(19) United States
(12) Patent Application Publication
(10) Pub. No.: US 2009/0000480 A1
(43) Pub. Date: Jan. 1, 2009

(54) Composite Palladium Membrane Having Long-Term Stability for Hydrogen Separation

(76) Inventors: Zissis Dardas, Worcester, MA (US); Ying She, Worcester, MA (US); Thomas Henry Vanderspurt, Glastonbury, CT (US); Jean Yamanis, South Glastonbury, CT (US); Craig Walker, South Glastonbury, CT (US)

Correspondence Address: Stephen A. Schneeberger, 49 Arlington Road, West Hartford, CT, 06107, US

(21) Appl. No.: 12/086,936

(22) PCT Filed: Dec. 23, 2005
(86) PCT No.: PCT/US2005/047047

§ 371 Date: Jun. 20, 2008

(51) Int. Cl. B01D 53/22

(52) U.S. Cl. 96/11

(57) ABSTRACT

The materials of adjoining porous metal substrate (12), oxide (14), and Pd-alloy membrane (16) layers of a composite, H2—separation palladium membrane (10) have respective thermal expansion coefficients (TEC) which differ from one another so little as to resist failure by TEC mismatch from thermal cycling. TEC differences (20, 22) of less than 3 μm/(m.k) between materials of adjacent layers are achieved by a composite system of a 446 stainless steel substrate, an oxide layer of 4 wt % yittria-zirconia, and a 77 wt % Pd-23 wt % Ag or 60 wt % Pd-40 wt % Cu, membrane, having TECs of 11, 11, and 13.9 μm/(m.k), respectively. The Intermediate oxide layer comprises particles forming pores having an average pore sizeless than 5 microns, and preferably less than about 3 microns, in thickness.

The U.S. Government has a paid-up license in this invention and the right in limited circumstances to require the patent owner to license others on reasonable terms as provided for by the terms of (contract No. DE-FC36-02AL67628) awarded by the Department of Energy.

### TECHNICAL FIELD

This invention relates to selective gas separation, and more particularly to palladium membranes for the separation of hydrogen from a gas stream. More particularly still, the invention relates to composite palladium membranes for hydrogen separation.

### BACKGROUND ART

Gas separation and purification devices are used to selectively separate one or more target gasses from a mixture containing those and other gasses. One well known example is the use of certain membranes for the selective separation of hydrogen (H₂) from a stream, flow, or region containing hydrogen in a mixture with other gasses. While the membranes for the selective separation of H₂ might generally be polymers or metal, the polymer membranes are typically limited to use in low temperature environments. In circumstances where the membranes must be used in conjunction with high temperature processes, or processing, it becomes necessary to rely upon metal membranes.

In a typical example, the H₂ may be the product of a reformation and/or water gas shift reaction of a hydrocarbon fuel, and the H₂, following separation from other reformate or reaction gasses, may be used in a relatively pure form as a reducing fuel for the well-known electrochemical reaction in a fuel cell. The processes associated with the reformation and/or water gas shift reactions are at such elevated temperatures, as for example, reactor inlet temperatures of 700° C. and 400° C. respectively, that H₂ separation, at or near those temperatures, requires the use of metal membranes. The metal perhaps best suiting these needs is palladium, which is selectively permeable to H₂, relative to other gasses likely to be present, and has high durability at these operating temperatures.

Composite palladium or its alloy membranes, consisting of a thin palladium layer deposited on a porous metal (PM), oxidation resistant substrate, when integrated with the reformer or the water gas shift reactor, result in desirable H₂ permeation flux and offer significant advantages towards system size and cost reduction. Pd—Ag and Pd—Cu-based alloys are required for extended membrane stability in a sulfur-free or sulfur containing reformate, respectively, with the former being quite important for fuel cell power plants requiring a number of start up and shut down cycles. For a palladium alloy membrane to be produced by electroless plating (EP) or certain other techniques, high temperature thermal treatment, e.g., in the 550° C.-650° C. temperature regime, in a controlled atmosphere is needed in the latter stages of the process. However, this thermal treatment will cause intermetallic diffusion of the porous metal substrate constituents into the Pd phase that is detrimental to H₂ permeance. An effective way to produce a Pd alloy membrane with the previously stated manufacturing processes is to provide the palladium membrane substrate with a thin ceramic layer that will serve as an intermetallic diffusion barrier. Examples of such techniques may be found in, for example, U.S. Pat. No. 6,152,987 and U.S. published applications US 2004/0237779 and 2004/0244590 by Y. H. Ma, et al. In the instances cited above, this ceramic interlayer is grown thermally, either as an oxide from the metal support or as a separate phase like nitride from N₂ decomposition or carbide from a carbon-containing gas stream. The palladium membrane support is thermally treated in air, nitrogen or a carbon-containing gas at extreme temperatures and prolonged times to achieve this result.

A limitation with respect to the techniques described above is the mismatch of the thermal expansion coefficients (hereinafter, “TEC”) among the Pd alloy, the ceramic interlayer and the PM support, which can result in membrane catastrophic failure (spalling) during thermal cycling or start up/shut down events. Indeed, a typical thermal cycle may experience temperatures ranging from ambient to 400° C. in a water gas shift reactor and to 600° C. if in a reformer reactor, and such cycling may occur frequently, particularly if the reformer and/or water gas shift reactor(s), and thus also the PD membrane, are part of a fuel processing system for a fuel cell power plant which undergoes frequent starting and stopping, such as for automotive use, etc.

Referring to FIG. 1, there is depicted a simplified, diagrammatic, sectional view of a composite, H₂-separation membrane 110 in accordance with the prior art as described in the aforementioned U.S. patent of Y. H. Ma, et al. More particularly, the composite membrane 110 is comprised of a porous metal substrate 112, typically of 316L stainless steel (SS), a porous intermediate oxide layer 114, and a dense palladium, or palladium alloy, membrane layer 116. Based on the description provided in the aforementioned U.S. patent, it can be discerned that the 316L SS substrate 112 will have a TEC of about 17.2 μm/(m° K); the intermediate oxide layer 114, created by oxidation of the support, will be a mixture of Cr2O3, NiO and iron-oxide, with the Cr2O3 being the dominant phase and thus, a TEC of about 8.5 μm/(m.K); and the palladium phase of the membrane layer 116 is 11.7-13.9 μm/(m.K), depending on the alloy composition. If the differences (i.e., “Δ”) between TECs of materials in adjacent layers 112 and 114, and 114 and 116, in the composite membrane 110 are considered, as represented by brackets 120 and 122, respectively, it is seen that significant disparity in the TECs of adjacent materials exists.

Alternatively, in the aforementioned published applications of Ma et al, a so-called intermediate layer is formed by alternating layers of Pd and Ag, which have TECs of 11.7 and 20.6 μm/(m ° K), respectively. From that description, it will be further evident that the Δ between TECs of adjoining layers, or sub-layers, continues to be significant and represent a TEC mismatch.

What is needed is a composite, H₂-separation, palladium membrane that is structurally stable, durable and cost effective for operation over frequent and/or extreme thermal cycles.

What is further needed is a composite, H₂-separation, palladium membrane that resists or avoids membrane catastrophic failure (spalling) during thermal cycling or start up/shut down events.

What is even further needed is a composite, H₂-separation, palladium membrane that avoids or minimizes the mismatch of the thermal expansion coefficients (TEC) among the Pd alloy, the ceramic interlayer, and the palladium membrane support.

### DISCLOSURE OF INVENTION

The present invention is concerned with providing a composite, H₂-separation, palladium membrane that is structurally stable, durable and cost effective for operation over frequent and/or extreme thermal cycles. This is obtained by matching, to the extent technically possible and economically feasible, the thermal expansion coefficients (TECs) of the materials of the several component layers that make up the composite membrane.

The composite, H₂-separation membrane of the invention comprises a porous metal substrate having a first TEC; an intermediate layer of oxidehaving a second TEC, wherein the intermediate layer overlies the porous metal substrate; a membrane of Pd alloy having a third TEC, wherein the membrane of Pd alloy overlies the intermediate layer; and wherein the porous metal substrate, the intermediate oxide layer, and the membrane of Pd alloy are selected such that their respective said first, second, and third TECs are sufficiently similar as to resist failure due to thermal cycling.

More specifically, the thermal expansion coefficients of each of the porous metal substrate, the intermediate layer, and the membrane of Pd alloy differ from that of the next adjacent one of the substrate, the intermediate layer, and the Pd alloy membrane by less than about 3 μm/(m.K). Moreover, the difference of the TECs across all three layers cumulatively is also less than about 3 μm/(m.K). In a preferred embodiment, the porous metal substrate is of 446 Stainless Steel (known in the trade as E-Brite) having a TEC of about 11 μm/(m.K), the intermediate layer is a very thin coating of 4 wt % Yttria-ZrO₂ having a TEC of about 11 μm/(m.K), and the membrane of Pd alloy is formed of either Pd—Ag or Pd—Cu, depending on the presence, or not, of sulfur. If little or no sulfur is anticipated in the reformate being processed, then the membrane is of Pd—Ag, typically a 77 wt % PD-23 wt % Ag alloy having a desirable TEC of about 13.9. Alternatively, if the presence of sulfur is anticipated, then the membrane is of Pd—Cu, typically 60 wt % Pd-40 wt % Cu having a TEC of about 13.9.

The durability and integrity of the composite membrane are further enhanced by the intermediate layer being very thin, less than about 3 microns, and having a controlled particle size that results in a very narrow pore-size distribution. That pore-size distribution ranges between about 0.02 and 0.2 microns, and the average pore size (diameter) is less than about 0.1 microns. This facilitates the further application of a very thin (less than 10 microns) layer of the Pd alloy membrane, as by electroless plating.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a simplified, diagrammatic, sectional view of a composite, H₂-separation membrane with associated thermal expansion coefficients, according to the prior art; and

FIG. 2 is a simplified, diagrammatic, sectional view of the composite, H₂-separation membrane with associated thermal expansion coefficients, in accordance with the invention.

### BEST MODE FOR CARRYING OUT THE INVENTION

Referring to FIG. 2, there is illustrated, in simplified diagrammatic form, a sectional view of a portion of a composite H₂-separation membrane 10 in accordance with the invention. The separation membrane 10 may be planar in form, as is illustrated herein solely for convenience; however a preferred configuration would be tubular to define there within either a reaction flow path for the reformate or a collection chamber for the separated and diffused hydrogen. The composite H₂-separation membrane 10 is generally comprised of a support, or substrate, layer 12, a thin intermediate layer of oxide 14, and a membrane layer 16 of Pd alloy.

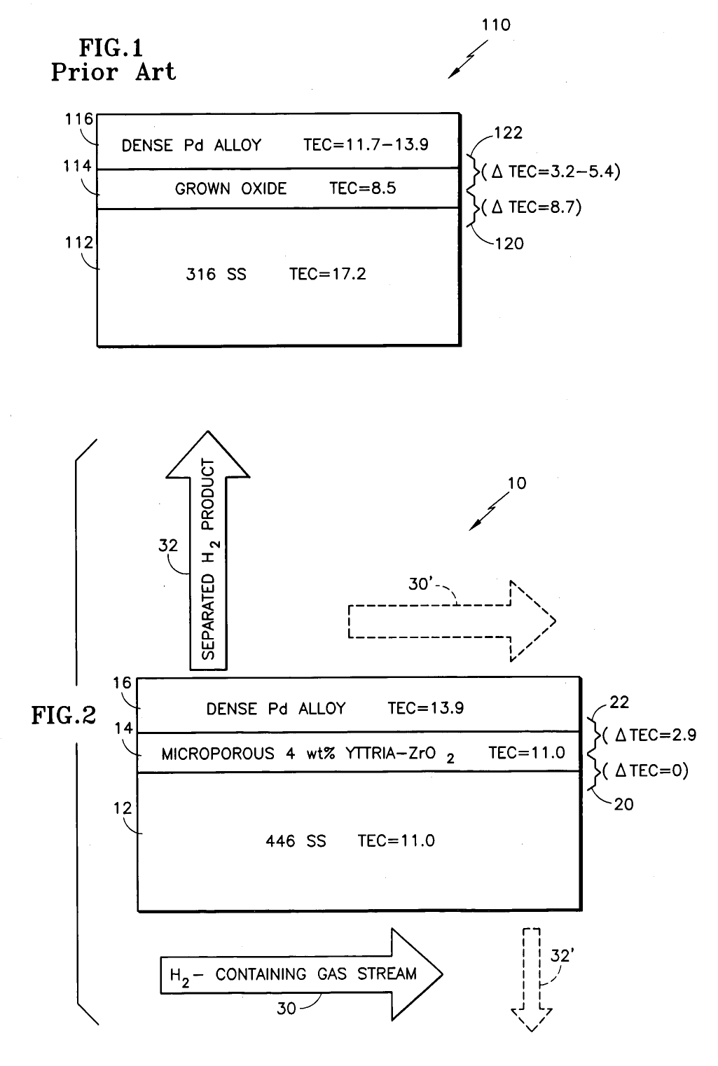

In use, a hydrogen-containing gas stream, represented by arrow 30, flows adjacent a surface of the composite membrane 10. Hydrogen may dissociate and pass through the composite membrane 10 and appear as separated hydrogen product beyond the opposite surface, as represented by the arrow 32. The broken-line arrows 30′ and 32′ are included to show that the dissociative flow path may be reversed from one side of the composite membrane to the other. In these respects, the H₂-separation membrane of the invention is similar to the prior art composite membrane 110 depicted in FIG. 1.

The several layers of the composite, H₂-separation membrane 10 are integrally joined to one another, as by appropriate bonding, deposition, plating and/or other suitable techniques. The composite H₂-separation membrane 10 is intended and suited for use in a reactor environment, as in the fuel processing system for a fuel cell power plant, wherein operating temperatures typically range from ambient to 600° C., and may undergo thermal cycling across that range as frequently as 5 times per day, particularly if in an automotive application.

In order to provide the durability required for extended life and operation of the composite H₂-separation membrane 10 under such operating conditions, the substrate layer 12, the intermediate layer 14 and the Pd-alloy membrane layer 16 are carefully selected to be of materials and associated thermal expansion coefficients that provide not only the requisite selectivity to the passage of substantially only hydrogen therethrough, but also the durability to withstand the thermal cycling and operating conditions. Accordingly, the invention provides that the materials to be used in each of the three mentioned layers have respective thermal expansion coefficients (TEC) that are sufficiently similar, particularly for adjacent layers, as to resist failure due to thermal cycling. More specifically, the invention provides for the TEC's of the materials in adjacent layers to differ (Δ) by no more than 3 μm/(m.K) from each other. In the extreme, the invention provides for the difference of the TECs across all three layers cumulatively to be less than about 3 μm/(m.K).

It has been determined that such similarity of TECs in the materials of adjacent layers results in substantially greater life relative to the composite H₂-separation membranes of the prior art, such as discussed in the aforementioned Ma et al patent and published patent applications. This is particularly the case when operating under the frequent, significant thermal cycling conditions described previously.

As noted earlier in the discussion of the composite membrane 110 in FIG. 1 of the prior art, the substrate 112 was of 316L stainless steel, which has a TEC of 17.2 μm/(m.K). The layer 114 adjacent to that substrate 112 was an oxide in the aforementioned Ma et al patent, and may be preferably also in the published applications, though they are less clear in that regard. The membrane layer 116, and perhaps even a so-called “intermediate layer” between the oxide layer and the membrane layer, were of palladium (Pd) silver (Ag) alloy. The palladium typically has a TEC of 11.7 μm/(m.K) and the silver has a TEC of 20.6 (see Table 1 below).

The TEC of alloys can be estimated by the following expression:

TEC=ΣTECᵢ*Yᵢ (1)

where TECᵢ is the TEC of element i in the alloy and Yᵢ is the volume fraction of this element, defined by the following expression:

Yᵢ=(Mᵢ/ρᵢ)/ΣMᵢ/ρᵢ (2)

where Mᵢ is the mass fraction of element i in the alloy expressed as (wt %/100) and ρi is the density of this element in gr/cm³.

Based on the preceding system for estimating the TEC of alloys, one can conclude that the mixture of Cr2O3, NiO and iron-oxide that formed the Ma et al oxide layer, with the Cr2O3 being the dominant phase, would have a TEC of about 8.5 μm/(m.K). Further, the overlying layer, or layers, of Pd and Ag alloy would have a TEC in the range of 20.6 to 16.5, depending on the relative amounts of Pd and Ag.

Returning to a consideration of the materials of the composite H₂-separation membrane 10 of the present invention, the Pd-alloy membrane 16 is preferably an alloy of Pd and Ag if operation is expected to take place in the substantial absence of sulfur, and is an alloy of Pd and Cu if significant sulfur is expected to be present. Referring to Table 1 below, the TEC values, for temperatures up to 700° C., for several materials germane to this invention and/or the Ma et al patent publications, are listed:

TABLE 1

| | E-brite (446 | | | | | 77% Pd- | 60% Pd- | 316L |
|---|---|---|---|---|---|---|---|---|
| Materials | SS alloy) | Y—ZrO₂ | Cu | Ag | Pd | 23%-Ag | 40% Cu | SS alloy |
| TEC, | 11 | 11 | 16.5 | 20.6 | 11.7 | 13.9 | 13.9 | 17.2 |
| μm/(m · K) | | | | | | | | |

As noted above, alloys of Pd and Ag should have TECs in the range of 11.7 to 20.6 μm/(m.K), depending upon the relative contents of Pd and Ag. Similarly, alloys of Pd and Cu should have TECs in the range of 11.7 to 16.5 μm/(m.K), depending upon therelative contents of Pd and Cu. It has been found that the Pd-alloys should preferably have a relatively greater content of Pd than either Ag or Cu to provide the desired H₂-selective permeability, yet the cost of pure palladium and/or the vulnerability to sulfur make the inclusion of the Ag or Cu desirable. In the instance of contemplated operation in a practically sulfur-free environment, a preferred alloy is Pd 77 wt %-Ag 23 wt %. This alloy formulation is chosen for the reasons above and to minimize H₂ embrittlememt that may otherwise occur during power plant shutdown. By substituting the TEC values for Pd and Ag into Equations (1) and (2), a TEC of 13.9 μm/(m.K) is determined for this preferred PdAg membrane alloy. For operation in a sulfur environment, a membrane alloy formulation of 60 wt % Pd and 40 wt % Cu has been found preferable, for which the TEC is determined to also be 13.9 μm/(m.K).

The membrane 16 is applied to substrate 12, typically via a oxide intermediate layer 14, by any of a variety of suitable processes, with electroless plating being preferred. The membrane 16 is typically formed of a series of integral layers applied by the electroless plating process, and which are subsequently heat treated in a controlled gas atmosphere usually containing hydrogen at temperatures in the 450-550° C. regime and times between 4 to 20 hrs, depending on the temperature, in order to form the Pd alloy.

In further accordance with the invention, the substrate 12 is a metal selected to be porous to hydrogen atoms, durable, of acceptable cost, and particularly, to have a TEC that is relatively similar to that of the membrane 16, and also to the intermediate oxide layer 14. Accordingly, the substrate 12 is porous 446 stainless steel, known also as E-Brite). That 446 stainless steel of the substrate 12 has a TEC of 11.0 μm/(m.K), such that it is not greatly different from the TECs of either of the preferred Pd alloys of membrane 16, or, as seen from the following, from the TEC of the intermediate oxide layer 14.

It is necessary that the porous 446 stainless steel of the substrate 12 be coated with a very thin (<5 microns, and preferably 1-3 microns) oxide layer 14. The preferred material of that oxide layer is Yttria (4 wt %)-stabilized Zirconia (Y-ZrO₂). The particle size within the Y-ZrO₂ coating forming layer 14 is carefully controlled, by the selection of the powder used to make the slurry for the coating process, to provide a very narrow pore size (diameter) distribution ranging from 0.02 to 0.2 microns, with an average pore size of less than about 0.1 microns. This thin, oxide, intermediate layer 14 with well-controlled pore size distribution, resulting from the control of particle size, is critical for achieving uniform, defect-free and very thin (<10 microns) over-layer(s) 16 of the Pd-alloy by electroless plating, as well as for minimizing the mass transfer resistance of the H₂ flux through this layer, either into or from the porous metal of the substrate 12. Here also, the choice of yittria (4 wt %)—stabilized zirconia as the material for the intermediate layer 14 was made to achieve a minimization of any mismatch between the TECs of the materials of the adjacent substrate 12 and the Pd-alloy membrane 16. Specifically, the particular Y-ZrO₂ has a TEC of 11.0 μm/(m.K), making it particularly thermally compatible with the 446 SS of the substrate 12, and acceptably so with the Pd-alloy membrane 16 as well.

Indeed, referring further to FIG. 2, it will be seen that the difference (Δ) between TECs for the adjoining substrate layer 12 and intermediate oxide layer 14, as represented by bracket 20, is zero (0), resulting in an ideal thermal match. The difference (Δ) between TECs for the adjoining intermediate oxide layer 14 and Pd-alloy membrane layer 16, as represented by bracket 22, is about 2.9 μm/(m.K). This, too, is relatively small, and provides a very acceptable thermal match between materials. Moreover, the cumulative difference of the TECs across all three layers, 12, 14 and 16, is also less than about 3 μm/(m.K). These values contrast with the significantly greater Δ TEC values 120 and 122 of the prior art, which are 8.7 and 3.2-5.5, respectively. The composite, H₂-separation, palladium membrane of the present invention demonstrates a clear advantage with respect to these thermal cycling properties.

Although the invention has been described and illustrated with respect to the exemplary embodiments thereof, it should be understood by those skilled in the art that the foregoing and various other changes, omissions and additions may be made without departing from the spirit and scope of the invention.

What is claimed is:

1. A composite, H₂-separation membrane (10), comprising, in joined sequence:
a porous metal substrate (12) having a first thermal expansion coefficient;
an intermediate layer (14) of oxide having a second thermal expansion coefficient, wherein the intermediate layer overlies the porous metal substrate (12);
a membrane (16) of Pd alloy having a third thermal expansion coefficient, wherein the membrane of Pd alloy overlies the intermediate layer (14); and
wherein the porous metal substrate, the intermediate layer, and the membrane of Pd alloy are selected such that their respective said first, second, and third thermal expansion coefficients are sufficiently similar as to resist failure due to thermal expansion coefficient mismatch within the composite, H₂-separation membrane during thermal cycling.

2. The composite, H₂-separation membrane of claim 1, wherein said first, said second, and said third thermal expansion coefficients of the porous metal substrate, the intermediate layer, and the membrane of Pd alloy respectively, are each less than 3 μm/(m.K) different (20, 22) from the thermal expansion coefficient of the next adjacent one of the porous metal substrate, the intermediate layer, and the membrane of Pd alloy.

3. The composite, H₂-separation membrane of claim 2, wherein said first, said second, and said third thermal expansion coefficients of the porous metal substrate, the intermediate layer, and the membrane of Pd alloy respectively, differ cumulatively (20, 22) by no more than 3 μm/(m.K).

4. The composite, H₂-separation membrane of claim 3, wherein said first, said second, and said third thermal expansion coefficients of the porous metal substrate, the intermediate layer, and the membrane of Pd alloy respectively, are about 11, 11, and 13.9 μm/(m.K), respectively.

5. The composite, H₂-separation membrane of claim 2, wherein said porous metal substrate is stainless steel, the intermediate layer is Yittria-ZrO₂, and the membrane of Pd alloy is from the group consisting of Pd—Ag and Pd—Cu.

6. The composite, H₂-separation membrane of claim 5, wherein said porous metal substrate is 446 stainless steel, the intermediate layer is 4 wt % Yittria-ZrO₂, and the membrane of Pd alloy is from the group consisting of 77 wt % Pd-23 wt % Ag and 50 wt % Pd-40 wt % Cu.

7. The composite, H₂-separation membrane of claim 1, wherein the intermediate layer is an oxide and comprises particles forming pores having an average pore size less than about 0.1 microns and is less than about 3 microns in average thickness.

8. The composite, H₂-separation membrane of claim 7, wherein the membrane of Pd alloy is less than about 10 microns in thickness.
